(19) United States
(12) Patent Application Publication
(10) Pub. No.: US 2008/0305840 A1
(43) Pub. Date: Dec. 11, 2008

(54) Clip for wireless devices

(76) Inventor: Pi-Fen Lin, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/808,444

(22) Filed: Jun. 11, 2007

(51) Int. Cl. H04M 1/00

(52) U.S. Cl. 455/575.1

(57) ABSTRACT

A clip for wireless devices includes a first branch arm and a second branch arm. One end of the first branch arm is connected with one end of the second branch arm. The first branch arm has a through hole and a restricting hole. The second branch arm has a clipping flake. The clipping flake has a connecting hole. Thereby, the wireless device passes through the through hole and slides to the restricting hole so that the wireless device is fastened on to the first branch arm, and the wireless device can also be slid to the through hole and taken off. The wireless device is clipped to the clothes by using the clipping flake and the second branch arm or is hung on the button of clothing. The user's appearance is unaffected, and it is convenient for the user to take off or carry the wireless device.

### BACKGROUND OF THE INVENTION

1. Field of the Invention

The present invention relates to a clip for wireless devices. In particular, this invention relates to a clip for wireless devices that a user can easily take off or carry the wireless device.

2. Description of the Related Art

Wireless communication technology has been widely applied to portable personal communication devices. For example, a variety of wireless earphones have been developed to cooperate with cell phones. The user wears the earphones to form a connection with the cell phone. The user can transmit via wireless communication technology to receive or operate the cell phone without having to hold the cell phone.

Due to the developments of the semiconductor manufacturing process and ICs, electronic devices have become smaller and lighter. Electronic devices with a small and light design do not occupy a large space. Because there is no handy receiving device for the user to hang onto and take off from the receiving device, it is inconvenient for the user. For example, wireless devices (such as cell phones or wireless earphones) are usually placed in a backpack, a purse, or the pocket of the user. It is inconvenient for the user to carry. Alternatively, as shown in FIG. 5, the wireless device is connector with a hanging belt 6 so that the wireless device is hung around the neck of the user like a necklace. The hanging belt 6 usually doesn't match the outfit of the user so their appearance is affected. When the wireless earphone is clipped on clothes via an ear hanger, it easily becomes detached.

### SUMMARY OF THE INVENTION

One particular aspect of the present invention is to provide a clip for wireless devices. The clip is used for receiving and hanging the wireless device (such as a cell phone or a wireless earphone) so that it clips onto the clothes or connects with a button of an item of clothing. The wireless device can be easily taken off from the clip.

The clip for wireless devices includes a first branch arm, and a second branch arm. One end of the first branch arm is connected with one end of the second branch arm. The first branch arm has a through hole and a restricting hole. The through hole links with the restricting hole at the edge of the holes. The second branch arm has a clipping flake. The clipping flake extends from one end of the second branch arm to a second end of the second branch arm. The clipping flake has a connecting hole.

The present invention has the following characteristics. The wireless device can pass through the through hole and slide to the restricting hole so that the wireless device is hung around and fastened on the first branch arm, and the wireless device can be slid to the through hole and taken off. Next, the wireless device is clipped to the user's clothes by using the clipping flake and the second branch arm or is hung on a button of an item of clothing via the connecting hole. Thereby, the user's appearance is unaffected by the wireless device, and it is convenient for the user to take off or carry the wireless device.

For further understanding of the invention, reference is made to the following detailed description illustrating the embodiments and examples of the invention. The description is only for illustrating the invention and is not intended to be considered limiting of the scope of the claim.

### BRIEF DESCRIPTION OF THE DRAWINGS

The drawings included herein provide a further understanding of the invention. A brief introduction of the drawings is as follows:

FIG. 1 is a perspective view of the clip for wireless devices of the present invention;

FIG. 2 is another perspective view of the clip for wireless devices of the present invention;

FIG. 3 is a schematic diagram of the clip for wireless devices of the present invention;

FIG. 4 is a schematic diagram of the clip for wireless devices of the present invention being used; and

FIG. 5 is a perspective view of the wireless device of the prior art hung around the neck of the user.

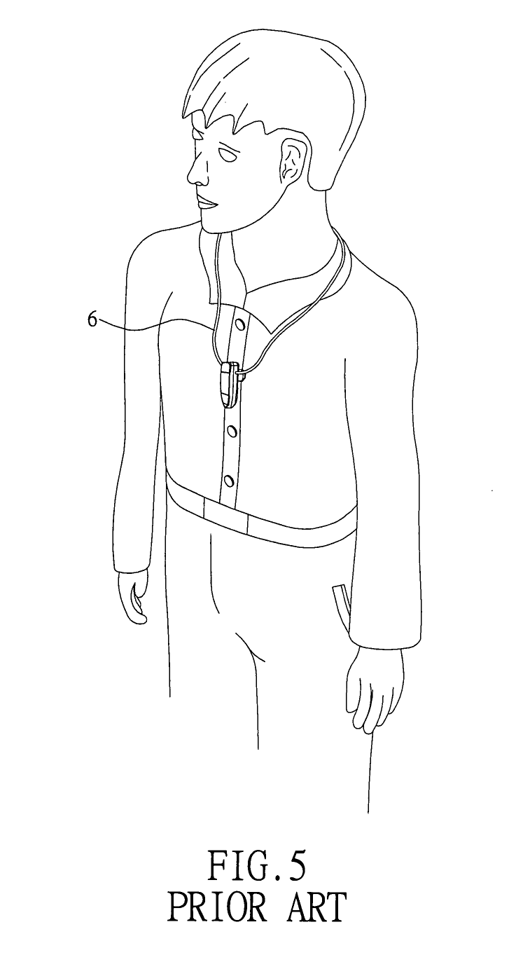

### DETAILED DESCRIPTION OF THE PREFERRED EMBODIMENTS

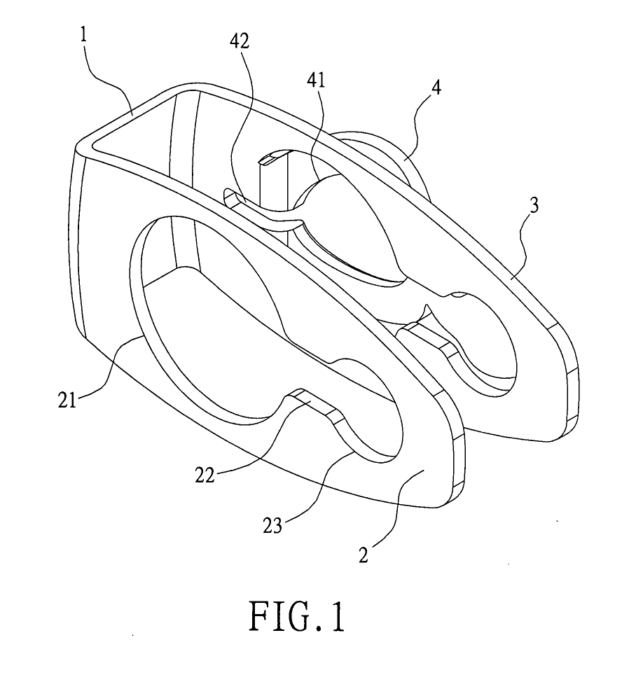

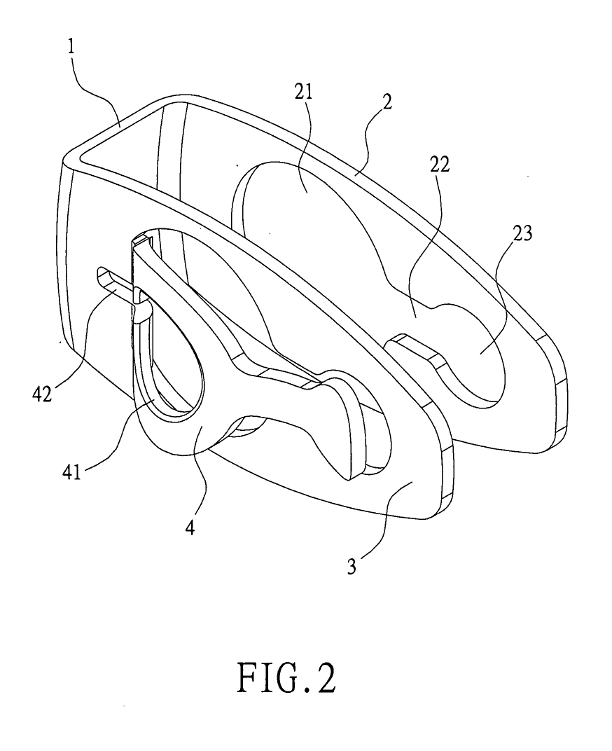

Reference is made to FIGS. 1 and 2. The clip for wireless devices includes a connecting portion 1, a first branch arm 2, a second branch arm 3, and a clipping flake 4. The first branch arm 2 and the second branch arm 3 respectively extend from two ends of the connecting portion 1 in the same direction. The connecting portion 1, the first branch arm 2, and the second branch arm 3 form a U-shaped body.

The first branch arm 2 has a through hole 21, a guiding channel 22, and a restricting hole 23. The through hole 21 links with the restricting hole 23 via the guiding channel 22. The diameter of the through hole 21 is larger than the diameter of the restricting hole 23. The clipping flake 4 is formed on one end of the second branch arm 3 and bulges outwards. One end of the clipping flake 4 is connected with one end of the second branch arm 3 and is adjacent to the connecting portion 1. The clipping flake 4 has a connecting hole 41.

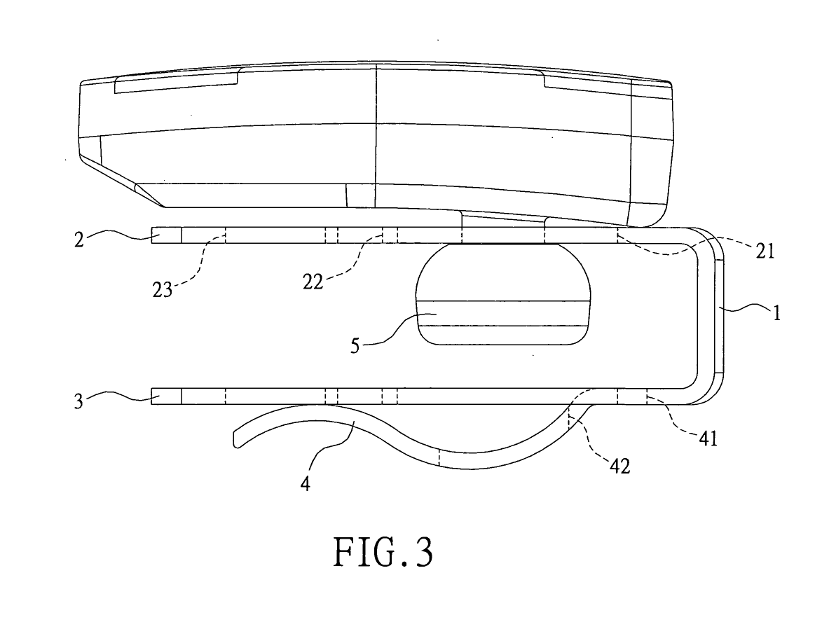

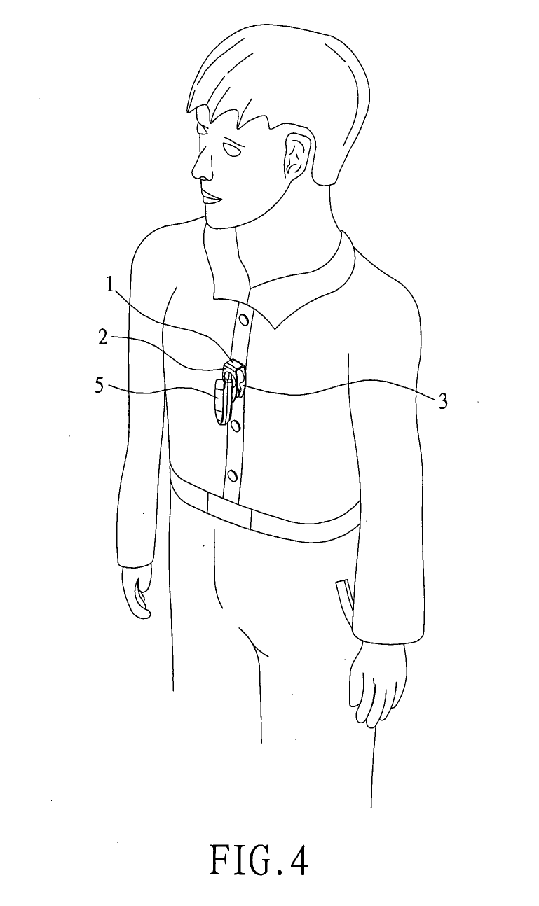

Reference is made to FIGS. 3 and 4. The clip for wireless devices can be connected with a wireless earphone 5. The wireless earphone 5 is passed through the through hole 21 and is slid along the guiding channel 22 to the restricting hole 23, thereby, the wireless phone 5 is fastened on the restricting hole 23. When the user wishes to use the wireless earphone 5, the wireless earphone 5 is slid along the guiding channel 22 to the through hole 21 and the wireless earphone is taken off.

The user can use the clipping flake 4 located on the second branch arm 3 to clip the wireless device to clothes, or pass the button of an item of clothing through the connecting hole 41 so that it hangs on item of clothing (as shown in FIG. 4). The edge of the connecting hole 41 further has a ditch 42 (as shown in FIGS. 1 and 2). The seamed wire of the button can be wedged into the ditch 42.

The present invention uses the first branch arm 2 to hang a wireless device (such as the wireless earphone 5 in FIGS. 3 and 4, or a cell phone with a button design), and uses the second branch arm 3 and the clipping flake 4 to connect with the clothes or a button of an item of clothing of the user. Thereby, whatever kind of clothes the user is wearing, the user can clip the wireless device to their clothes, or hang the wireless device on the button of an item of clothing. Their appearance is unaffected. The wireless device can be safely and easily received in the restricting hole 23 of the first branch arm 2 to be carried or can be taken off from the clip. The connecting portion 1, the first branch arm 2, the second branch arm 3 and the clipping flake 4 are flexible metal elements or plastic elements. The structure is simple, and can be integrated into one piece. The manufacturing process is simple.

The description above only illustrates specific embodiments and examples of the invention. The invention should therefore cover various modifications and variations made to the herein-described structure and operations of the invention, provided they fall within the scope of the invention as defined in the following appended claims.

What is claimed is:

1. A clip for wireless device, comprising:
a first branch arm; and
a second branch arm;
wherein one end of the first branch arm is connected with one end of the second branch arm, the first branch arm has a through hole and a restricting hole, the through hole links with the restricting hole at the edge of the holes, the second branch arm has a clipping flake, the clipping flake extends from one end of the second branch arm to a second end of the second branch arm, and the clipping flake has a connecting hole.

2. The clip for wireless devices as claimed in claim 1, further comprising a connecting portion, wherein the first branch arm is connected with the second branch arm via the connecting portion.

3. The clip for wireless devices as claimed in claim 1, wherein an edge of the connecting hole has a ditch.

4. The clip for wireless devices as claimed in claim 1, wherein the first branch arm, the second branch arm, and the clipping flake are flexible metal elements or plastic elements.
